(19) United States
(12) Patent Application Publication
(10) Pub. No.: US 2026/0243313 A1
(43) Pub. Date: Aug. 20, 2026

(54) A ONE-WAY CLUTCH WITH TAPER ROLLERS

(71) Applicant: TEXSPIN BEARINGS LIMITED, Ahmedabad, Gujarat (IN)

(72) Inventor: Vishal Makwana, Ahmedabad, Gujarat (IN)

(21) Appl. No.: 19/161,337

(22) PCT Filed: Jan. 13, 2024
(86) PCT No.: PCT/IB2024/050356

§ 371 Date: Sep. 2, 2025

(30) Foreign Application Priority Data
Mar. 2, 2023 (IN) 202321014187

(51) Int. Cl. F16D 41/067; F16D 41/061

(52) U.S. Cl. CPC F16D 41/067; F16D 41/061

(57) ABSTRACT

A one-way clutch 200 includes an outer body 202 with an inner periphery and a conical inner surface 204, a shaft 206 with a cylindrical outer surface 208, a plurality of taper rollers 210 disposed in a plurality of pockets 214 open towards the shaft 206, and a plurality of springs 216 configured to bias the plurality of taper rollers 210 in an axial direction towards a lower diameter side of the respective taper rollers 210. Further, a counter-clockwise rotation of the shaft 206, when viewed from bigger end side of the rollers 210, is blocked on account of tendency of the rollers 210 to move axially towards a narrower side of the conical inner surface 204 of the an outer body 202 due to rotation of the taper rollers 210 on the cylindrical outer surface of the shaft 206 and the biasing force from the springs 216.

### TECHNICAL FIELD

The present disclosure relates generally to the technical field of one-way clutches. In particular, it pertains to a one-way clutch assembly with tapered rollers.

### BACKGROUND

Background description includes information that may be useful in understanding the present invention. It is not an admission that any of the information provided herein is prior art or relevant to the presently claimed invention, or that any publication specifically or implicitly referenced is prior art.

One-way clutches are widely used in automotive industry as a torque transmitting or back stop device. Majorly, it is used with starter motor of IC engines to crank the engine for starting the engine. The one-way clutch allows transmission of torque and rotation from the starter motor to the engine, but prevents the engine, when started, to drive the starter motor.

Refereeing to FIG. 1 where a sectional view of a conventional one-way clutch 100 having an outer ring 102 having a plurality of pockets 104, each having a cam surface 106. A plurality of cylindrical rollers 108 are placed in each of the plurality of pockets 104 disposed between an outer surface of a shaft 112 and the respective cam surfaces 106. These rollers 108 are tangentially spring loaded by accordion spring 110. The cam surfaces are configured to cause wedging action and prevent rolling of the rollers 108 in the biasing direction thereby preventing rotation of the shaft 112 in the corresponding direction, but allow the rollers to roll when pushed towards the springs, thereby allowing rotation of the shaft 112 in the opposite direction.

The conventional one-way clutches suffer from drawback that they include cam surfaces having a complex geometry for wedging action, which cam surface is difficult to manufacture. Besides, the conventional one-way clutches include is complicated and difficult to assemble. Furthermore, a lot of space is required to accommodate the accordion spring 110. Specifically, a spring locking arrangement is required in the profile of the outer ring 102, which, if eliminated, can be used for accommodating additional rollers leading to a higher load carrying capacity of the bearing. Thus, the conventional design requiring one spring 110 for each of the rollers 108 suffers from packaging problem, which limits load carrying capacity of the bearing within a given size of the bearing.

Efforts have been made in the art to eliminate the requirement of cam surfaces in one-way clutches. For example, Patent Document U.S. Pat. No. 3,557,921 discloses a one-way clutch having inner and outer races formed in a shape of a taper roller bearing. Between the inner and outer races are interposed cylindrical rollers which are appropriately inclined with respect to the generating line of surfaces of the inner and outer races. In one of the directions of relative rotation of the races, the rollers act as wedges between the races to effect clutch action.

Another Patent Document U.S. Pat. No. 5,653,320 discloses a tapered roller one-way clutch for use with vertical shafts having an outside surface comprising a clutch housing having a bore extending through the housing and the vertical shaft rotatably inserted into the bore, a plurality of roller pockets are formed on the inside surface of the bore, the roller pockets extend axially along the inside surface of the bore from near the top of the bore to near the bottom of the bore and are spaced equally around a circumference of the bore, each roller pocket further comprises a roller landing tapering away from the axis of the bore to a roller shoulder formed along a diameter of the bore, a tapered roller having an outer surface is rotatably held in each roller pocket by the shaft outside surface, the roller landing is inclined to the axis of the bore to allow the outer roller surface to roll along the shaft outside surface and hold the tapered roller at an angle to maximize surface contact, the roller landing having an arcuate or helical shape from the roller shoulder to the inside cylindrical surface to allow the tapered roller to roll along and move laterally as the vertical shaft is moved in a clutching direction causing the tapered roller to bind the vertical shaft between the roller landing and the outside shaft Surface.

The cited references disclose different types of one-way clutches, including a one-way clutch based on tapered roller. However, the one-way clutch of prior art using tapered roller suffers from the drawback in that it can be used only in configurations where the corresponding shaft is vertically oriented.

There is, therefore, a need in the art to provide a simple, improved, and cost-effective one-way clutch that eliminates above mentioned limitation of the known one-way clutch based on the tapered rollers.

### OBJECTS OF THE INVENTION

A general object of the present disclosure is to provide a simple, improved, and cost-effective one-way clutch.

It is an object of the present disclosure is to provide a one-way clutch that is easy to manufacture.

Another object of the present disclosure is to provide an improved one-way clutch based on tapered rollers.

Another object of the present disclosure is to provide a one-way clutch based on tapered rollers that can be used in any orientation of the corresponding shaft.

Another object of the present disclosure is to provide a solution to problem of packaging springs in the conventional one-way clutches.

Yet another object of the present disclosure is to provide a one-way clutch that optimizes the load carrying capacity for a given size of the one-way clutch.

### SUMMARY

The present disclosure relates generally to the technical field of one-way clutches. In particular, it pertains to a one-way clutch assembly that is based on tapered rollers (also referred to as taper roller(s), herein).

In an aspect, the disclosed one-way clutch includes an outer body (also referred to simply as body, hereinafter) with an inner periphery having a conical inner surface, a shaft including an outer periphery having a cylindrical outer surface, and a plurality of taper rollers (also simply referred to as rollers and the two terms used interchangeably hereinafter) configured between the conical inner surface of the body and the cylindrical outer surface of the shaft. The one-way clutch further includes a single spring configured to bias the plurality of taper rollers in an axial direction towards a lower diameter side of the respective taper rollers (also referred to simply as roller(s), hereinafter). Rotation of the shaft in counter-clockwise direction, when viewed from a bigger end side of the rollers, is blocked on account of wedging action of the taper rollers caused by a biasing force from the spring.

In an aspect, the plurality of rollers is supported by a single spring, The spring has a desired profile design comprising a plurality of spring elements such that each of the plurality of rollers is supported by one spring element from big end face to bias the rollers towards the small end of the rollers.

In an aspect, the spring may be configured such that when the shaft is rotated in clockwise direction, when viewed from a bigger end side of the rollers, the biasing force of the spring is overcome by a tendency of the rollers to move axially towards a larger diameter side of the conical inner surface of the body, thereby eliminating the wedging action of the rollers to allow free rotation of the shaft.

In an embodiment, the body may include a plurality of pockets and the plurality of rollers are located within the plurality of pockets, one taper roller in each of the plurality of pockets. Each of the pockets may have a profile that includes the conical inner surface to create the wedging action to lock the corresponding rollers in position.

In an embodiment, the inner periphery of the body may be a truncated periphery including a plurality of segments, each segment located within a corresponding pocket.

In an embodiment, the one-way clutch may further include a top plate to hold the plurality of taper rollers within the pockets and the spring positioned adjacent the rollers. The top plate may be fixed to the body by crimping. In an embodiment, the plurality of pockets may be open towards the shaft facilitating contact between the rollers and the shaft.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates a sectional view of a conventional one-way clutch.

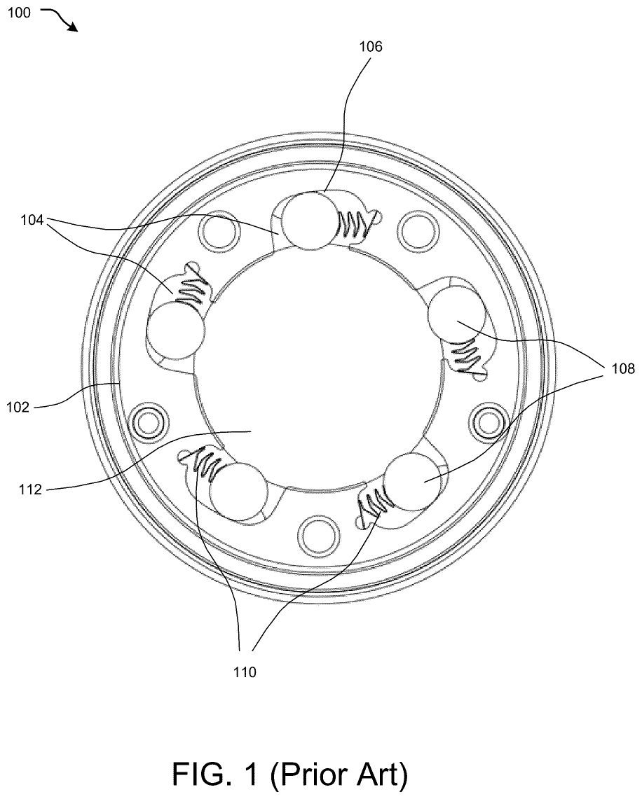

FIG. 2 illustrates an exemplary sectional view of the proposed one-way clutch along a plane perpendicular to an axis of the one-way clutch, in accordance with embodiments of the present disclosure.

FIG. 3 illustrates an exemplary sectional side view of the disclosed one-way clutch along a diametrical plane of the one-way clutch, in accordance with a first embodiment of the one-way clutch having a top plate and a spring having a plurality of spring elements.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate generally to a one-way clutch that is based on taper rollers. In an aspect, use of taper rollers in place of cylindrical rollers that are conventionally used in one-way clutches, does away with requirement of biasing the rollers in radial/tangential direction, and replaced by axial biasing. The springs required for axial biasing are more reliable as they are fixed between a top plate and a body of the one-way clutch and are not prone to getting dislodged from their position. In another aspect, the axial biasing can be provided by spring elements built into a single spring positioned at one end of the rollers between the rollers and a top plate. In an alternate embodiment, the spring elements can also be built into the top plate, which further improves reliability. Besides, in either case, the proposed change makes the assembly process easier and less time consuming.

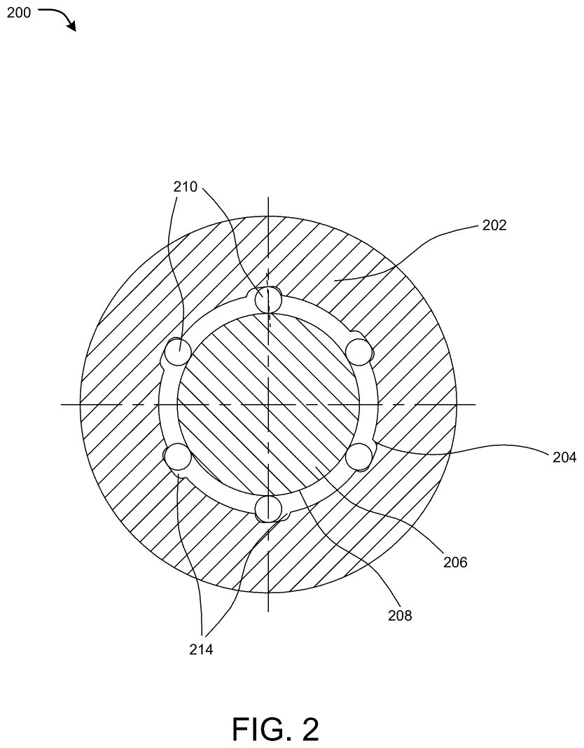

Referring to FIG. 2, where an axial sectional view perpendicular to the axis of the disclosed one-way clutch is shown, the one-way clutch 200 can include an outer body 202 with an inner periphery and a plurality of taper rollers 210 (also simply referred to as rollers 210, herein) disposed in a plurality of pockets 214 configured on an inner side of the an outer body 202, The pockets 214 can include a conical inner surface 204 (also simply referred to as conical surface 204, herein), with which outer conical surface of the taper rollers 210 can engage. The pockets 214 can be open on inner side (referred to as inner opening, hereinafter) such that the rollers 210 can be in contact with an outer cylindrical surface of a cylindrical shaft 206 (also simply referred to as shaft 206, herein) placed within the outer body 202. The shaft 206 includes a cylindrical outer surface 208.

In an embodiment, the inner openings of the pockets can be sized smaller than diameter of the roller 210, such as diameter at the bigger end of the rollers 210. This avoids dislodging of the tapper rollers 210 from the pockets when there is no shaft 206 in position.

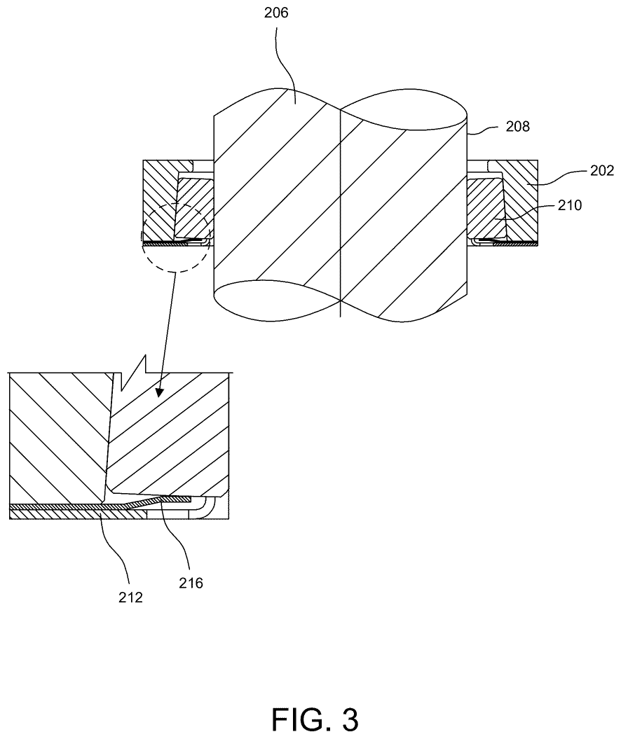

In an embodiment, the one-way clutch 200 can further include a top plate 212 (refer FIG. 3) to axially restrain the plurality of taper rollers 210. Further, a plurality of spring 216 are positioned between the top plate 212 and the rollers 210 to axially bias the rollers 210. The top plate 212 can be fixed to the outer body 202 by crimping. In an embodiment, the functionality of the plurality of springs 216 can be combined in a single part placed between the outer body 202 and the top plate 212.In an embodiment, the conical surface 204 and the rollers 210 can be configured such that the rollers 210 are biased by springs 216 in an axial direction towards a lower diameter side of the respective taper rollers 210. For example, a larger diameter side of the conical surface 204 of the pockets 214 can be towards the top plate 212.

In an embodiment, the plurality of spring 216 can be spring elements/fingers (also referred to as springs 216, herein) built into a single profiled plate/diaphragm spring that can be positioned at one end of the rollers between the rollers 210 and the top plate 212 such that the profiled spring elements/fingers 216 are in contact with the large diameter side of the rollers 210 to axially bias the respective rollers 210.

FIG. 3 shows a sectional side view of the disclosed one-way clutch 200 with first embodiment and with a second embodiment respectively, in respect of the springs and the top plate.

In the first embodiment shown in FIG. 3, the top plate 212 and the springs 216 are different parts with the springs 216 positioned between the rollers and the top plate 212 such that each spring 216 biases one of the rollers 210.

Thus, the present disclosure provides a robust one-way clutch that replaces springs that bias the rollers in radial direction by springs that do axial biasing, which are inherently more stable, thereby overcoming the problem associated with the conventional one-way clutches. The use of springs that bias the rollers axially frees the space utilized by the springs in conventional designs, enabling increased load carrying capacity as well as simplifying the construction. Besides, absence of cavities in the outer body to locate the springs makes the outer body stronger, which also helps to increase the load carrying capacity of the clutch. Therefore, for a given size of the clutch, load carrying capacity increases. Alternatively, for a given load carrying capacity, size of the clutch gets reduced, making packaging of the clutch easier.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

A general advantage of the present disclosure is that it provides a simple, improved, and cost-effective solution for one-way clutch.

The present disclosure provides a one-way clutch that is easy to manufacture.

The present disclosure provides an improved one-way clutch based on tapered rollers.

The present disclosure provides a one-way clutch based on tapered rollers that can be used in any orientation of the corresponding shaft.

The present disclosure provides a solution to the problem of packaging springs in the conventional one-way clutches.

The present disclosure provides a one-way clutch that optimizes the load carrying capacity for a given size of the one-way clutch.

We claim:

1. A one-way clutch (200), comprising:
an outer body (202) comprising an inner periphery with a conical inner surface (204);
a shaft (206) comprising an outer periphery having a cylindrical outer surface (208);
a plurality of taper rollers (210) configured between the conical inner surface (204) of the an outer body (202) and the cylindrical outer surface (208) of the shaft (206); and
a plurality of springs (216) configured to bias the plurality of taper rollers (210) in an axial direction towards a lower diameter side of the respective taper rollers (210);
wherein rotation of the shaft (206) in counter clockwise direction, when viewed from a bigger end side of the taper rollers (210), is blocked on account of wedging action of the taper rollers (210) caused by a biasing force from the springs (216).

2. The one-way clutch as claimed in claim 1, wherein the springs (216) are configured as fingers of a single diaphragm spring.

3. The one-way clutch as claimed in claim 1, wherein the springs (216) are configured such that when the shaft (206) is rotated in clockwise direction, when viewed from a bigger end side of the taper rollers (210), the biasing force of the springs (216) is overcome by a tendency of the taper rollers (210) to move axially towards a larger diameter side of the conical inner surface (204) of the outer body (202).

4. The one-way clutch as claimed in claim 1, wherein the outer body (202) comprises a plurality of pockets (214) and the plurality of taper rollers (210) are located within the plurality of pockets (214), one taper roller (210) in each of the plurality of pockets (214).

5. The one-way clutch as claimed in claim 1, wherein the plurality of pockets (214) comprise a profiled surface that includes the conical inner surface to create the wedging action.

6. The one-way clutch as claimed in claim 4, wherein the inner periphery of the outer body (202) is a truncated periphery comprising a plurality of segments, each segment located within a corresponding pocket (214).

7. The one-way clutch as claimed in claim 4, wherein the one-way clutch (200) further comprises a top plate (212) to hold the plurality of taper rollers (210) and the springs (216) within the pockets (214), wherein the top plate (212) is fixed to the outer body (202) by crimping.

8. The one-way clutch as claimed in claim 4, wherein the plurality of pockets (214) are open towards the shaft (206) facilitating contact between the taper rollers (210) and the shaft(206).
